(19) United States
(12) Patent Application Publication
(10) Pub. No.: US 2021/0141351 A1
(43) Pub. Date: May 13, 2021

(54) DECLARATIVE INTENTIONAL PROGRAMMING IN MACHINE-TO-MACHINE SYSTEMS

(71) Applicant: Intel Corporation, Santa Clara, CA (US)

(72) Inventors: Shao-Wen Yang, San Jose, CA (US); Yen-Kuang Chen, Palo Alto, CA (US)

(73) Assignee: Intel Corporation, Santa Clara, CA (US)

(21) Appl. No.: 16/488,575

(22) PCT Filed: Mar. 31, 2017
(86) PCT No.: PCT/US17/25241

§ 371 Date: Aug. 23, 2019

(51) Int. Cl. G05B 19/042; G06F 8/30; G16Y 10/80; G16Y 10/75; H04L 29/08

(52) U.S. Cl. CPC G05B 19/042; G06F 8/311; G16Y 10/80; H04L 67/10; H04L 67/2804; G05B 2219/2642; G16Y 10/75

(57) ABSTRACT

A user input including an identification of a set of job abstractions is received, where each job abstraction in the set of job abstractions includes a respective one of a plurality of defined job abstractions and each of the plurality of defined job abstractions are mapped to two or more asset capability abstractions in a plurality of defined asset capability abstractions. The user input is processed to generate program data, based on the set of job abstractions. The resulting program data is executable by a processor device to: identify a set of asset capability abstractions in the plurality of asset capability abstractions corresponding to the set of job abstractions; determine that a set of devices in an environment possess capabilities corresponding to the set of asset capability abstractions; and launch a system including the set of devices to implement jobs corresponding to the set of job abstractions.

### TECHNICAL FIELD

This disclosure relates in general to the field of computer systems and, more particularly, to managing machine-to-machine systems.

### BACKGROUND

The Internet has enabled interconnection of different computer networks all over the world. While previously, Internet-connectivity was limited to conventional general purpose computing systems, ever increasing numbers and types of products are being redesigned to accommodate connectivity with other devices over computer networks, including the Internet. For example, smart phones, tablet computers, wearables, and other mobile computing devices have become very popular, even supplanting larger, more traditional general purpose computing devices, such as traditional desktop computers in recent years. Increasingly, tasks traditionally performed on a general purpose computers are performed using mobile computing devices with smaller form factors and more constrained features sets and operating systems. Further, traditional appliances and devices are becoming “smarter” as they are ubiquitous and equipped with functionality to connect to or consume content from the Internet. For instance, devices, such as televisions, gaming systems, household appliances, thermostats, automobiles, watches, have been outfitted with network adapters to allow the devices to connect with the Internet (or another device) either directly or through a connection with another computer connected to the network. Additionally, this increasing universe of interconnected devices has also facilitated an increase in computer-controlled sensors that are likewise interconnected and collecting new and large sets of data. The interconnection of an increasingly large number of devices, or “things,” is believed to foreshadow a new era of advanced automation and interconnectivity, referred to, sometimes, as the Internet of Things (IoT).

### BRIEF DESCRIPTION OF THE DRAWINGS

FIG. 1A illustrates an embodiment of a system including multiple sensor devices and an example management system;

FIG. 1B illustrates an embodiment of a cloud computing network; FIG. 2 illustrates an embodiment of a system including an example declarative programming tool;

FIGS. 3A-3B are simplified block diagrams illustrating example programming paradigms for Internet of Things (IoT) systems;

FIG. 4A is a simplified block diagram illustrating an example of asset abstraction and binding;

FIG. 4B is a simplified block diagram illustrating an example of asset discovery;

FIG. 4C is a simplified block diagram illustrating an example of asset abstraction and binding using a discovered set of assets;

FIGS. 5A-5B are illustrations of the use of job abstractions in an example abstraction architecture;

FIG. 6 is a simplified block diagram illustrating generation and deployment of an example IoT application;

FIG. 7 is a simplified block diagram illustrating an example of deploying a particular user-authored IoT application in two different machine-to-machine systems;

FIG. 8 is a flowchart illustrating an example technique for deploying an example machine-to-machine network utilizing asset abstraction;

FIG. 9 is a block diagram of an exemplary processor in accordance with one embodiment; and

FIG. 10 is a block diagram of an exemplary computing system in accordance with one embodiment.

Like reference numbers and designations in the various drawings indicate like elements.

### DETAILED DESCRIPTION OF EXAMPLE EMBODIMENTS

FIG. 1A is a block diagram illustrating a simplified representation of a system 100 that includes one or more devices 105a-d, or assets, deployed throughout an environment. Each device 105a-d may include a computer processor and/or communications module to allow each device 105a-d to interoperate with one or more other devices (e.g., 105a-d) or systems in the environment. Each device can further include one or more instances of various types of sensors (e.g., 110a-c), actuators (e.g., 115a-b), storage, power, computer processing, and communication functionality which can be leveraged and utilized (e.g., by other devices or software) within a machine-to-machine, or Internet of Things (IoT) system or application. Sensors are capable of detecting, measuring, and generating sensor data describing characteristics of the environment in which they reside, are mounted, or are in contact with. For instance, a given sensor (e.g., 110a-c) may be configured to detect one or more respective characteristics such as movement, weight, physical contact, temperature, wind, noise, light, computer communications, wireless signals, position, humidity, the presence of radiation, liquid, or specific chemical compounds, among several other examples. Indeed, sensors (e.g., 110a-c) as described herein, anticipate the development of a potentially limitless universe of various sensors, each designed to and capable of detecting, and generating corresponding sensor data for, new and known environmental characteristics. Actuators (e.g., 115a-b) can allow the device to perform (or even emulate) some kind of action or otherwise cause an effect to its environment (e.g., cause a state or characteristics of the environment to be maintained or changed). For instance, one or more of the devices (e.g., 105b, d) may include one or more respective actuators that accepts an input and perform its respective action in response. Actuators can include controllers to activate additional functionality, such as an actuator to selectively toggle the power or operation of an alarm, camera (or other sensors), heating, ventilation, and air conditioning (HVAC) appliance, household appliance, in-vehicle device, lighting, among other examples. Actuators may also be provided that are configured to perform passive functions.

In some implementations, sensors 110a-c and actuators 115a-b provided on devices 105a-d can be assets incorporated in and/or forming an Internet of Things (IoT) or machine-to-machine (M2M) system. IoT systems can refer to new or improved ad-hoc systems and networks composed of multiple different devices interoperating and synergizing to deliver one or more results or deliverables. Such ad-hoc systems are emerging as more and more products and equipment evolve to become “smart” in that they are controlled or monitored by computing processors and provided with facilities to communicate, through computer-implemented mechanisms, with other computing devices (and products having network communication capabilities). For instance, IoT systems can include networks built from sensors and communication modules integrated in or attached to “things” such as equipment, toys, tools, vehicles, etc. and even living things (e.g., plants, animals, humans, etc.). In some instances, an IoT system can develop organically or unexpectedly, with a collection of sensors monitoring a variety of things and related environments and interconnecting with data analytics systems and/or systems controlling one or more other smart devices to enable various use cases and application, including previously unknown use cases. Further, IoT systems can be formed from devices that hitherto had no contact with each other, with the system being composed and automatically configured spontaneously or on the fly (e.g., in accordance with an IoT application defining or controlling the interactions). Further, IoT systems can often be composed of a complex and diverse collection of connected devices (e.g., 105a-d), such as devices sourced or controlled by varied groups of entities and employing varied hardware, operating systems, software applications, and technologies.

Facilitating the successful interoperability of such diverse systems is, among other example considerations, an important issue when building or defining an IoT system. Software applications can be developed to govern how a collection of IoT devices can interact to achieve a particular goal or service. In some cases, the IoT devices may not have been originally built or intended to participate in such a service or in cooperation with one or more other types of IoT devices. Indeed, part of the promise of the Internet of Things is that innovators in many fields may dream up new applications involving diverse groupings of the IoT devices as such devices become more commonplace and new “smart” or “connected” devices emerge. However, the act of programming, or coding, such IoT applications may be unfamiliar to many of these potential innovators, thereby limiting the ability of these new applications to be developed and come to market, among other examples and issues.

As shown in the example of FIG. 1A, multiple IoT devices (e.g., 105a-d) can be provided from which one or more different IoT applications can be built. For instance, a device (e.g., 105a-d) can include such examples as a mobile personal computing device, such as a smart phone or tablet device, a wearable computing device (e.g., a smart watch, smart garment, smart glasses, smart helmet, headset, etc.), purpose-built devices such as and less conventional computer-enhanced products such as home, building, vehicle automation devices (e.g., smart heat-ventilation-air-conditioning (HVAC) controllers and sensors, light detection and controls, energy management tools, etc.), smart appliances (e.g., smart televisions, smart refrigerators, etc.), and other examples. Some devices can be purpose-built to host sensor and/or actuator resources, such as a weather sensor devices that include multiple sensors related to weather monitoring (e.g., temperature, wind, humidity sensors, etc.), traffic sensors and controllers, among many other examples. Some devices may be statically located, such as a device mounted within a building, on a lamppost, sign, water tower, secured to a floor (e.g., indoor or outdoor), or other fixed or static structure. Other devices may be mobile, such as a sensor provisioned in the interior or exterior of a vehicle, in-package sensors (e.g., for tracking cargo), wearable devices worn by active human or animal users, an aerial, ground-based, or underwater drone among other examples. Indeed, it may be desired that some sensors move within an environment and applications can be built around use cases involving a moving subject or changing environment using such devices, including use cases involving both moving and static devices, among other examples.

Continuing with the example of FIG. 1A, software-based IoT management platforms can be provided to allow developers and end users to build and configure IoT applications and systems. An IoT application can provide software support to organize and manage the operation of a set of IoT device for a particular purpose or use case. In some cases, an IoT application can be embodied as an application on an operating system of a user computing device (e.g., 125) or a mobile app for execution on a smart phone, tablet, smart watch, or other mobile device (e.g., 130, 135). In some cases, the application can have an application-specific management utility allowing users to configure settings and policies to govern how the set devices (e.g., 105a-d) are to operate within the context of the application. A management utility can also be used to select which devices are used with the application. In other cases, a dedicated IoT management application can be provided which can manage potentially multiple different IoT applications or systems. The IoT management application, or system, may be hosted on a single system, such as a single server system (e.g., 140) or a single end-user device (e.g., 125, 130, 135). Alternatively, an IoT management system can be distributed across multiple hosting devices and systems (e.g., 125, 130, 135, 140, etc.).

In still other examples, IoT applications may be localized, such that a service is implemented utilizing an IoT system (e.g., of devices 105a-d) within a specific geographic area, room, or location. In some instances, IoT devices (e.g., 105a-d) may connect to one or more gateway devices (e.g., 150) on which a portion of management functionality (e.g., as shared with or supported by management system 140) and a portion of application service functionality (e.g., as shared with or supported by application system 145). Service logic and configuration data may be pushed (or pulled) from the gateway device 150 to other devices within range or proximity of the gateway device 150 to allow the set of devices (e.g., 105a-d and 150) to implement a particular service within that location. A gateway device (e.g., 150) may be implemented as a dedicated gateway element, or may be a multi-purpose or general purpose device, such as another IoT device (similar to devices 105a-d) that itself may include sensors and/or actuators to perform tasks within an IoT system, among other examples.

In some cases, applications can be programmed, or otherwise built or configured, utilizing interfaces of an IoT management system. In some cases, the interfaces can adopt asset abstraction to simplify the IoT application building process. For instance, users can simply select classes, or taxonomies, of devices and logically assemble a collection of select devices classes to build at least a portion of an IoT application (e.g., without having to provide details regarding configuration, device identification, data transfer, etc.). To further simplify the IoT application building process, additional abstractions may be defined and implemented in an IoT application programming tool (e.g., provided with or separate from an IoT management system) to allow users to define the “what” the intended for the function of the IoT system rather than the “how,” as is typically the focus in programming. Abstraction-based programming may also facilitate portability and reusability of some IoT applications (e.g., across different systems using different collections of devices). For instance, IoT application systems built using an example IoT management system can be sharable, in that a user can send data identifying the built system to another user, allowing the other user to simply port the abstracted system definition to the other user's environment (even when the combination of device models is different from that of the original user's system). Additionally, system or application settings, defined by a given user, can be configured to be sharable with other users or portable between different environments, among other example features.

In some cases, IoT systems can interface (through a corresponding IoT management system or application or one or more of the participating IoT devices) with remote services, such as data storage, information services (e.g., media services, weather services), geolocation services, and computational services (e.g., data analytics, search, diagnostics, etc.) hosted in cloud-based and other remote systems (e.g., 140, 145). For instance, the IoT system can connect to a remote service (e.g., hosted by an application server 145) over one or more networks 120. In some cases, the remote service can, itself, be considered an asset of an IoT application. Data received by a remotely-hosted service can be consumed by the governing IoT application and/or one or more of the component IoT devices to cause one or more results or actions to be performed, among other examples.

One or more networks (e.g., 120) can facilitate communication between sensor devices (e.g., 105a-d), end user devices (e.g., 125, 130, 135), and other systems (e.g., 140, 145) utilized to implement and manage IoT applications in an environment. Such networks can include wired and/or wireless local networks, public networks, wide area networks, broadband cellular networks, the Internet, and the like.

In general, “servers,” “clients,” “computing devices,” “network elements,” “hosts,” “system-type system entities,” “user devices,” “gateways,” “IoT devices,” “sensor devices,” and “systems” (e.g., 105a-d, 125, 130, 135, 140, 145, 150, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing apparatus. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

While FIG. 1A is described as containing or being associated with a plurality of elements, not all elements illustrated within computing environment 100 of FIG. 1A may be utilized in each alternative implementation of the present disclosure. Additionally, one or more of the elements described in connection with the examples of FIG. 1A may be located external to computing environment 100, while in other instances, certain elements may be included within or as a portion of one or more of the other described elements, as well as other elements not described in the illustrated implementation. Further, certain elements illustrated in FIG. 1A may be combined with other components, as well as used for alternative or additional purposes in addition to those purposes described herein.

As noted above, a collection of devices, or endpoints, may participate in Internet-of-things (IoT) networking, which may utilize wireless local area networks (WLAN), such as those standardized under IEEE 802.11 family of standards, home-area networks such as those standardized under the Zigbee Alliance, personal-area networks such as those standardized by the Bluetooth Special Interest Group, cellular data networks, such as those standardized by the Third-Generation Partnership Project (3GPP), and other types of networks, having wireless, or wired, connectivity. For example, an endpoint device may also achieve connectivity to a secure domain through a bus interface, such as a universal serial bus (USB)-type connection, a High-Definition Multimedia Interface (HDMI), or the like.

As shown in the simplified block diagram 101 of FIG. 1B, in some instances, a cloud computing network, or cloud, in communication with a mesh network of IoT devices (e.g., 105a-d), which may be termed a “fog,” may be operating at the edge of the cloud. To simplify the diagram, not every IoT device 105 is labeled.

The fog 170 may be considered to be a massively interconnected network wherein a number of IoT devices 105 are in communications with each other, for example, by radio links 165. This may be performed using the open interconnect consortium (OIC) standard specification 1.0 released by the Open Connectivity Foundation™ (OCF) on Dec. 23, 2015. This standard allows devices to discover each other and establish communications for interconnects. Other interconnection protocols may also be used, including, for example, the optimized link state routing (OLSR) Protocol, or the better approach to mobile ad-hoc networking (B.A.T.M.A.N.), among others.

Three types of IoT devices 105 are shown in this example, gateways 150, data aggregators 175, and sensors 180, although any combinations of IoT devices 105 and functionality may be used. The gateways 150 may be edge devices that provide communications between the cloud 160 and the fog 170, and may also function as charging and locating devices for the sensors 180. The data aggregators 175 may provide charging for sensors 180 and may also locate the sensors 180. The locations, charging alerts, battery alerts, and other data, or both may be passed along to the cloud 160 through the gateways 150. As described herein, the sensors 180 may provide power, location services, or both to other devices or items.

Communications from any IoT device 105 may be passed along the most convenient path between any of the IoT devices 105 to reach the gateways 150. In these networks, the number of interconnections provide substantial redundancy, allowing communications to be maintained, even with the loss of a number of IoT devices 105.

The fog 170 of these IoT devices 105 devices may be presented to devices in the cloud 160, such as a server 145, as a single device located at the edge of the cloud 160, e.g., a fog 170 device. In this example, the alerts coming from the fog 170 device may be sent without being identified as coming from a specific IoT device 105 within the fog 170. For example, an alert may indicate that a sensor 180 needs to be returned for charging and the location of the sensor 180, without identifying any specific data aggregator 175 that sent the alert.

In some examples, the IoT devices 105 may be configured using an imperative programming style, e.g., with each IoT device 105 having a specific function. However, the IoT devices 105 forming the fog 170 may be configured in a declarative programming style, allowing the IoT devices 105 to reconfigure their operations and determine needed resources in response to conditions, queries, and device failures. Corresponding service logic may be provided to dictate how devices may be configured to generate ad hoc assemblies of devices, including assemblies of devices which function logically as a single device, among other examples. For example, a query from a user located at a server 145 about the location of a sensor 180 may result in the fog 170 device selecting the IoT devices 105, such as particular data aggregators 175, needed to answer the query. If the sensors 180 are providing power to a device, sensors associated with the sensor 180, such as power demand, temperature, and the like, may be used in concert with sensors on the device, or other devices, to answer a query. In this example, IoT devices 105 in the fog 170 may select the sensors on particular sensor 180 based on the query, such as adding data from power sensors or temperature sensors. Further, if some of the IoT devices 105 are not operational, for example, if a data aggregator 175 has failed, other IoT devices 105 in the fog 170 device may provide substitute, allowing locations to be determined.

Further, the fog 170 may divide itself into smaller units based on the relative physical locations of the sensors 180 and data aggregators 175. In this example, the communications for a sensor 180 that has been instantiated in one portion of the fog 170 may be passed along to IoT devices 105 along the path of movement of the sensor 180. Further, if the sensor 180 is moved from one location to another location that is in a different region of the fog 170, different data aggregators 175 may be identified as charging stations for the sensor 180.

As an example, if a sensor 180 is used to power a portable device in a chemical plant, such as a personal hydrocarbon detector, the device will be moved from an initial location, such as a stockroom or control room, to locations in the chemical plant, which may be a few hundred feet to several thousands of feet from the initial location. If the entire facility is included in a single fog 170 charging structure, as the device moves, data may be exchanged between data aggregators 175 that includes the alert and location functions for the sensor 180, e.g., the instantiation information for the sensor 180. Thus, if a battery alert for the sensor 180 indicates that it needs to be charged, the fog 170 may indicate a closest data aggregator 175 that has a fully charged sensor 180 ready for exchange with the sensor 180 in the portable device.

With the growth of IoT devices and system, there are increasing numbers of smart and connected devices available in the market, such as devices capable of being utilized in home automation, factory automation, smart agriculture, and other IoT applications and systems. For instance, in home automation systems, automation of a home is typically increased as more IoT devices are added for use in sensing and controlling additional aspects of the home. However, as the number and variety of devices increase, the management of “things” (or devices for inclusion in IoT systems) becomes outstandingly complex and challenging.

As noted above, IoT devices are being developed at an increasing pace. Some IoT devices are developed for a particular type of management system or for interoperation with a limited set of other devices. However, such out-of-the-box solutions (while pre-configured for easy out-of-the box use and with pre-programmed IoT application) may have limited features and uses. In some environments, the users responsible for or desiring to set up an IoT system may be laypersons with no (or very limited) engineering or programming knowledge or experience. While some systems may allow the construction of custom systems and IoT applications, traditional programming tools for such systems are designed for users with some programming or networking expertise and may be too complicated to be useful to lay users. Accordingly, customized, extensible, and heterogeneous IoT system design has been largely kept from such users and prevented IoT systems, generally, from wide deployment and adoption. In many cases, traditional IoT programming tools are device-centric (demanding familiarity with the technical nuances and communication requirements of each respective device to be included in the system) rather than user-centric (and focused on addressing the needs and vantage point of user as they see the desired system).

In some implementations, an improved system may be provided with enhancements to address at least some of the example issues above. For instance, In modern societies, large numbers of people carry with them at least one electronic device that possesses network communication capabilities such as a smartphone, smartwatch, wearable, or other mobile device. In addition to network communication, such devices are also typically equipped with resources such as microphones, speakers and a variety of sensors (accelerometer, light, temperature etc.). The near ubiquitous presence of mobile devices, however, present opportunities for a wide array of machine-to-machine networks and corresponding services to be deployed. Gateway devices may be provided, to identify opportunities to interconnect or build services upon collections of devices within an area in an ad hoc and impromptu manner (e.g., without requiring device-specific configurations or user involvement in setting up the network and service).

Services that may be developed, ad hoc, using a collection of detected (and, in some cases, heterogeneous) mobile devices may include examples such as the deployment of an IoT service that intelligently uses the resources of nearby device to facilitate coordinated evacuation/rescue efforts (e.g., involving the users of the devices). For instance, smartphones in an affected area or building may be identified and configured to transmit location beacons, tune microphones to pick up and transmit certain categories of sounds or using speakers to emit sounds on a certain frequency when the device detects a specific sound pattern on another frequency used by rescuers, among other features. In another example, a collection of devices may be identified to provide an impromptu enhancement (video and/or audio) to social events such as concerts, sporting events, and the like (e.g., configuring a collection of smartphone screens or flashlights to create a visual mosaic inside a stadium).

Localized IoT services may also be launched such that they follow a mobile device from location to location, such that consistent IoT services (e.g., tuned to a particular user) are provided on varying sets of IoT devices within each location. For instance, an indoor environment control may be implemented based on smartphone sensor inputs and cause other smart IoT devices providing environmental services (e.g., lights, heating, ventilating, and air conditioning (HVAC) systems, speakers, etc.) to be configured to implement a preferred environment. For example, a system can use inputs from smartphone light and temperature sensors and preconfigured preferences to adjust lighting and heating based on when a person (and their phone) enters or leaves a room (e.g., of a home or office building). Further, IoT configurations and services that are personally adjusted from a “home” IoT system may be transported to other IoT systems being visited (e.g. to recreate aspects of a home environment inside a hotel room, vacation home, etc.). Further, personal IoT configurations and services may be sharable, such that users may access and adopt (or building upon) a desirable configuration created by another user for another set of devices, among other features.

To facilitate the deployment of impromptu IoT systems, improved IoT management functionality may be provided to utilize asset abstraction to significantly reduce the human touch points during deployment and redeployment. For instance, IoT management and applications can adopt a paradigm where, instead of referencing and being programmed to interoperate with specific IoT devices, the system can refer to abstracted classes, or taxonomies, of IoT devices (or “assets”). Asset abstraction can be leveraged to automatically configure a deployed IoT system with minimal human intervention. Indeed, in some instances, configuration of the system can progress without a user having to actually specify which device to use. Instead, a deployment policy can be used instead by the system to automatically select and configure at least a portion of the devices within the system. Further, asset abstraction can facilitate addressing the challenge of portability of IoT applications, which has traditionally limited the general scalability and resiliency of IoT applications.

Asset abstraction can be coupled with automated asset binding, in some cases, to eliminate the necessity of including a device/asset's unique ID in an IoT application or management program. Asset discovery provided with the application or management program can provide an effective means for specifying policy and confining the scope of asset binding. Through the combination of asset discovery, asset abstraction, and asset binding makes IoT applications portable, reusable and sharable. Further, ambient abstractions may be further defined and coupled with asset abstraction to facilitate declarative programming tools, which allow users to program an IoT application based on what a user would like to implement, rather than how to engineer this result at the device-level.

In some implementations, with asset abstraction, assets are treated indifferently as long they fall into a same category in the taxonomy, e.g., occupancy sensing, image capture, computation, etc. An IoT application, consequently, can be made portable, reusable and sharable, as it can be written and stored in a way that specifies only requirements (e.g., references to abstracted device taxonomies providing the requirements) without specifying the precise identity (or catalogue of identities) of compatible devices meant to provide these requirements. Asset discovery allows all available resources to be searched to detect those meeting the requirements and further selected, in some instances, on the basis of customizable or policy-based criteria.

Systems, such as those shown and illustrated herein, can include machine logic implemented in hardware and/or software to implement the solutions introduced herein and address at least some of the example issues above (among others). For instance, FIG. 2 shows a simplified block diagram 200 illustrating a system including multiple IoT devices (e.g., 105a-b) with assets (e.g., sensors (e.g., 110a) and/or actuators (e.g., 115a)) capable of being used in a variety of different IoT applications. In the example of FIG. 2, a gateway device 150 is provided with system manager logic 205 (implemented in hardware and/or software) to detect assets within a location and identify opportunities to deploy an IoT system utilizing the detected assets. In some implementations, at least a portion of the service logic (e.g., 220a) utilized to drive the function of the IoT application may be hosted on the gateway 150. Service logic (e.g., 220b) may also be hosted (additionally or alternatively) on one or more remote computing devices implementing a server of the service logic. The service logic (e.g., 220a-b) may be generated in connection with the programming of an example IoT application. The system manager 205, in some examples, may include functionality (e.g., 260) for programming the IoT application using declarative programming based on IoT abstraction layers (e.g., defined in abstraction data 215). In other cases, a declarative programming tool (e.g., 260) may be provided separate from the system manager 205 (and host (e.g., 150) of the system manager, such as through a remote or cloud-based host system, among other examples). Further, configuration data (e.g., 245a-b), for configuring the assets to be utilized in the deployment of the IoT system, may also be hosted on the gateway 150 and/or a remote server (e.g., 140), among other example implementations.

In the particular example of FIG. 2, the gateway 150 may include one or more data processing apparatus (or “processors”) 210, one or more memory elements 212, and one or more communication modules 214 incorporating hardware and logic to allow the gateway to communicate over one or more networks, utilizing one or a combination of different technologies (e.g., WiFi, Bluetooth, Near Field Communications, Zigbee, Ethernet, etc.), with other systems and devices (e.g., 105a, 105d, 140, 145, etc.). The system manager 205 may be implemented utilizing code accessible and executable by the processor 210 to manage the automated deployment of a local IoT system. Deployment of the IoT system may further include the selection and provisioning of service logic (e.g., 220a, 220b) consistent with the programming of the IoT system, for instance, using declarative programming tool 260. In one example, system manager 205 may include components such as an asset discovery module 225, asset abstraction manager 230, asset binding manager 235, configuration manager 240, runtime manager 250, and declarative programming tool 260, among other example components (or combinations of the foregoing).

In one example, an asset discovery module 225 may be provided with functionality to allow the gateway 150 to determine which IoT devices are within range of the gateway 150 and thus fall within a particular location for which one or more IoT services may be deployed. In some implementations, the asset discovery module 225 makes use of the wireless communication capabilities (e.g., 214) of the gateway 150 to attempt to communicate with devices within a particular radius. For instance, devices within range of a WiFi or Bluetooth signal emitted from the antenna(e) of the communications module(s) 214 of the gateway (or the communications module(s) (e.g., 262, 264) of the assets (e.g., 105a, d)) can be detected. Additional attributes can be considered by the asset discovery module 225 when determining whether a device is suitable for inclusion in a listing of devices for a given system or application. In some implementations, conditions can be defined for determining whether a device should be included in the listing. For instance, the asset discovery module 225 may attempt to identify, not only that it is capable of contacting a particular asset, but may also determine assets such as physical location, semantic location, temporal correlation, movement of the device (e.g., is it moving in the same direction and/or rate as the discovery module's host), permissions or access level requirements of the device, among other characteristics. As an example, in order to deploy smart lighting control for every room in a home- or office-like environment, an application may be deployed in a “per room basis.” Accordingly, the asset discovery module 225 can determine a listing of devices that are identified (e.g., through a geofence or semantic location data reported by the device) as within a particular room (despite the asset discovery module 225 being able to communicate with and detect other devices falling outside the desired semantic location).

Conditions for discovery can be defined in service logic (e.g., 220a-b) of a particular IoT application. Discovery conditions may be based or defined according to abstraction layers defined in abstraction data 215. For instance, criteria can be defined to identify which types of resources are needed or desired to implement an application. Such conditions can go beyond proximity, and include identification of the particular types of assets that the application is to use. For instance, the asset discovery module 225 may additionally identify attributes of the device, such as its model or type, through initial communications with a device, and thereby determine what assets and asset types (e.g., specific types of sensors, actuators, memory and computing resources, etc.) are hosted by the device. Accordingly, discovery conditions and criteria can be defined based on asset type abstractions (or asset taxonomies) and a type of job to be performed (e.g., a job abstraction, such as an ambient abstraction) defined for the IoT application. Some criteria may be defined that is specific to a particular asset types, where the criteria has importance for some asset types but not for others in the context of the corresponding IoT application. Further, some discovery criteria may be configurable such that a user can custom-define at least some of the criteria or preferences used to select which devices to utilize in furtherance of an IoT application (e.g., through definition of new abstractions to be included in one or more abstraction layers embodied in abstraction data).

A system manager 205 can also include an asset abstraction module 230. An asset abstraction module 230 can recognize defined mappings between specific IoT devices or, more generally, specific functionality that may be included in any one of a variety of present or future IoT devices with a collection of defined taxonomies, or device abstractions. The asset abstraction module 230 can determine, for each asset discovered by an asset discovery module 225 (e.g., according to one or more conditions), a respective asset abstraction, or taxonomy, to which the asset “belongs”. Each taxonomy can correspond to a functional capability of an asset. Assets known or determined to possess the capability can be grouped within the corresponding taxonomy. Some multi-function assets may be determined to belong to multiple of the taxonomies. The asset abstraction module 230 can, in some cases, determine the abstraction(s) to be applied to a given asset based on information received from the asset (e.g., during discovery by asset discovery module 225). In some cases, the asset abstraction module can obtain identifiers from each asset and query a backend database for pre-determined abstraction assignments corresponding to that make and model of asset, among other examples. Further, in some implementations, the asset abstraction module 230 can query each asset (e.g., according to a defined protocol) to determine a listing of the capabilities of the asset, from which the asset abstraction module 230 can map the asset to one or more defined abstraction taxonomies. Asset abstraction module 230 allows the application to treat every asset falling within a given taxonomy as simply an instance of that taxonomy, rather than forcing the system manager 205 to track every possible device model with which it might be asked to manage or service logic 202, 204 to be designed to consider every possible permutation of a particular type of device. Asset abstraction module 225 can access a taxonomy framework (defined on an application-, system-, or universal-basis) that abstracts away the precise device into taxonomies including higher- and lower-level taxonomies for sensing, actuating, computation, storage, and other taxonomies. With asset abstraction, assets are treated indifferently as long they fall into a same category in the taxonomy, e.g., occupancy sensing. Deployment of an IoT application, implemented through its corresponding service logic 202, 204 and configurations 206, 208, may be automated in part through asset abstraction, allowing applications to be developed and deployed without concern for the specific identities of the devices to be used in the system.

Abstraction layers used to define and deploy an IoT system may further include an abstraction layer corresponding to the type of task or job to be performed using a collection of assets. Identification of one or a collection of different job abstractions may be provided by a user to identify the “what” of an IoT application (e.g., what the IoT system is supposed to do under governance of the IoT application and corresponding service logic) and be processed by the declarative programming tool 260 to identify, from the job abstraction, a collection of asset abstractions that are to be deployed to realize the corresponding types of jobs associated with the set of selected job abstractions. The collection of asset abstraction may then be identified to be utilized (e.g., by an asset discovery module 225, asset abstraction module 230, asset binding module 235, etc.) to identify specific assets discovered within an environment and provision corresponding service logic and configuration data to implement the IoT application programmed using the job abstractions.

A system manager 205 can include an asset binding module 235 which can select, from the discovered assets (and based on job abstractions defined for a given IoT application), which assets to deploy for a system. In some cases, upon selecting an asset, the asset binding module 235 can operate with configuration manager 245 to send configuration information (e.g., 206, 208) to selected assets to cause each corresponding asset to be configured for use in a particular service. This can involve provisioning the asset with corresponding service logic code (e.g., to allow it to communicate and interoperate with the gateway, a backend server (e.g., 145), and/or other assets selected for deployment), logging in, unlocking, or otherwise enabling the asset, sending session data to or requesting a session with the asset, among other examples. In cases where multiple assets of the same taxonomy have been identified (and exceed a maximum desired number of instances of the taxonomy), the asset binding module 235 can additionally assess which of the assets is the best fit for the deployment. For instance, service logic (e.g., 202, 204) may define binding criteria indicating desirable attributes of assets to be deployed in an application. These criteria can be global criteria, applying to instances of every taxonomy, or can be taxonomy-specific (i.e., only applying to decisions between assets within the same taxonomy). Asset binding can provision the assets specified by the service logic (e.g., 202, 204) for deployment automatically (before or during runtime).

A system manager 205 can additionally provide functionality (e.g., through configuration manager 240) to allow settings to be applied to the selected asset taxonomies (or requirements) of the application 210 and the application 210 generally. A variety of different settings can be provided depending on the collection of assets to be used by the application and the overall objectives of the application. Default setting values can be defined and further tools can be provided to allow users to define their own values for the settings (e.g., a preferred temperature setting of an air conditioned, the number of second to lock a smart lock or locker, sensitivity setting utilized for triggering a motion sensor and control, etc.). What settings constitute the “ideal” may be subjective and involve some tinkering by the user. In some cases, settings may be automatically defined to correspond to job abstractions selected and forming the basis of a corresponding IoT application deployment. When a user is satisfied with the settings, the user may save the settings as a configuration. In some implementations, these configurations can be stored locally at a device (e.g., 105a, d), on the gateway 150 (e.g., local configurations 206), or on the cloud (e.g., remote configuration data 208). In some cases, configurations can be shared, such that a user can share the settings they found ideal with other users (e.g., friends or social network contacts, etc.). Configuration data can be generated from which the settings are automatically readopted at runtime by the system manager 205, each time a corresponding service is to deploy (e.g., using whatever assets are currently discoverable within a particular location). Consequently, while specific devices may only be loosely tied to any one user or gateway in a particular deployment of a service, settings can be strongly tied to a user or service, such that the user may migrate between environments and the service may be deployed in various environments, including environments with different sets of assets, with the same settings, or configuration, being applied in each environment. For instance, regardless of the specific device identifiers or implementations selected to satisfy the abstracted asset requirements of an application or service, the same settings can be applied (e.g., as the settings, too, are directed to the abstractions of the assets (i.e., rather than specific assets)). To the extent a particular setting does not apply to a selected instance of a taxonomy, the setting can be ignored. If a selected instance of a taxonomy possesses settings that are undefined by the user in the configuration (e.g., because they are unique to the particular asset), default values for these settings can be automatically set or the user can be alerted that these settings are undefined, among other examples.

A configuration manager 240 may be additionally used in runtime (e.g., during and following deployment of an IoT system) to cause particular settings to be applied at the IoT devices (assets) selected for deployment with the service. The system manager 205 may include logic enabling the system manager 205 (and its composite modules) to communicate using a variety of different protocols with a variety of different devices. Indeed, the system manager 205 can even be used to translate between protocols to facilitate asset-to-asset communications. Further, the configuration manager 240 can send instructions to each of the selected assets for deployment to prompt each asset to adjust settings in accordance with those defined for the asset taxonomy in the setting configuration defined in configuration data pushed to (or pulled from) the configuration manager 240 during (and potentially also after) deployment.

A system utilizing a gateway enhanced with system manager 205 may be enabled to combine automatic resource management/provisioning with auto-deployment of services (e.g., based on a particular IoT application defined using declarative programming tool 260). Further, a configuration manager 240 can allow resource configurations from one IoT system to be carried over and applied to another so that services can be deployed in various IoT systems. Additionally, a runtime manager 250 can be utilized to perform automated deployment and management of a service resulting from the deployment at runtime. Auto-configuration can refer to the configuration of devices with configurations stored locally (e.g., 245a) or on a remote node (e.g., 245b), to provide assets (and their host devices) with the configuration information to allow the asset to be properly configured to operate within a corresponding IoT system. As an example, a device may be provided with configuration information usable by the device to tune a microphone sensor asset on the device so that is might properly detect certain sounds for use in a particular IoT system (e.g., tune the microphone to detect specific voice pitches with improved gain). Auto-deployment of a services may involves identification (or discovery) of available devices, device selection (or binding) based on service requirements (configuration options, platform, and hardware), and automated continuous deployment (or re-deployment) to allow the service to adapt to evolving conditions.

In one example, a runtime manager 250 may be utilized to direct the deployment and running of a service on a set of devices within a location corresponding to gateway 150. In one example, runtime manager 250 may trigger asset discovery and binding (e.g., by asset discovery module 225 and asset binding manager 235) in connection with the deployment of a particular application (e.g., defined according to a set of job abstractions specified by a user). An application manger 255 may be provided for a particular application, or service, and may be used to communicate with deployed devices (e.g., 105a, b) to send data to the devices (e.g., to prompt certain actuators) or receive data (e.g., sensor data) from the devices. Application manager 255 may further utilize service logic and provide received data as inputs to the logic and use the service logic to generate results, including results which may be used to prompt certain actuators on the deployed devices (e.g., in accordance with job abstractions defined for the corresponding application). Runtime manager logic 250 may also be utilized in connection with security tools, to define security domains within a deployment, for instance, to secure communications between one or more of the deployed devices and the gateway and/or communications between the devices themselves, among other example.

A declarative programming tool 260 may be provided with or separate from a system manager 205 and may provide user interfaces through which IoT applications may be built by a user declaratively. For instance, a user may select (e.g., through a graphical, speech, gesture, or other user interface) one or more job abstractions defined in abstraction data 215 and provide parameters defining the metes and bounds, targets, or goals for each job type corresponding to the selected job abstractions. An IoT application definition may be generated based on the selected set of job abstractions. The job abstractions may be part of an abstraction layer coupled to an asset abstraction layer. Accordingly, asset abstractions may be identified from the selected job abstractions to identify the types of devices that are to be utilized, provisioned, and configured to implement the corresponding IoT application. In this manner, users can identify the desired function of the application without having to have knowledge of the specific details or code typically needed to deploy a heterogeneous, custom IoT system.

Portions of the application, or service logic, used to implement an IoT system deployment can be distributed, with service logic capable of being executed locally at the gateway (or even one of the deployment computing assets) and/or remote from the deployment location on a cloud-based or other remotely-located system (e.g., 145). Indeed, in some cases, the gateway (e.g., using runtime manager 250) may provide one or more assets or their host devices (e.g., 105a, b) with service logic for use during an IoT application's deployment. In some cases, the gateway 150 (and runtime manager 250) may manage deployment and execution of multiple different applications (e.g., with corresponding service logic). Different configurations (e.g., using different configuration data instances) of the same application may also be supported by a single gateway (e.g., 150). Once assets are provisioned, the deployed assets can be used collectively for achieving the goals and functionality designed for the application.

In some implementations a system (e.g., 145) may be provided to host and execute at least a portion of the service logic (e.g., 220b) to be utilized to implement an IoT application. In one example, a remote service system (e.g., 145) may be provided and can include one or more processors 262, one or more memory elements 264, among other components. The remote service system 145 may interface with one or more gateways (e.g., 150) used to implement one or more instances, or deployments, of a particular IoT application using one or more networks 120. Data can be provided by the gateways 150 reporting data received from deployed sensor assets (e.g., 110a) or reporting results of other service logic (e.g., 220a) executed within a deployed system, and the remote service system 145 can utilize this data as inputs for further processing at the remote service system 145 using service logic 204. The results of this processing may then be returned by the remote service system 145 to the requesting gateway (or even a different gateway) to prompt additional processing at the gateway and/or to trigger one or more actuator assets (e.g., 115a) to perform or launch one or more tasks or outcomes of the IoT application.

Configuration may also be assisted by remotely located (e.g., cloud-based) systems (e.g., 140). For instance, a configuration server 140 may be provided that includes one or more processors 266, one or more memory elements 268, among other components. In some cases, remote systems may simply host various configuration data describing various configurations that may be accessed by and applied in a deployment of an IoT system by a gateway 150. In other cases, a configuration server (e.g., 140) may include a configuration manager (e.g., 270) to coordinate with a gateway 150 to identify configuration data for a particular deployment. Configuration data (e.g., 245b) supplied by a configuration servicer (e.g., 140) may replace, supersede, or supplement local configuration data (e.g., 245a). A configuration server 140 may also facilitate the sharing and offloading of configuration data across platforms, making IoT system configurations “portable” between systems and locations (e.g., which may utilize different gateways (e.g., 150) with access to varied local configurations), among other examples. Further, a remote configuration manager 270 may replace, supersede, or supplement the functionality of configuration management logic (e.g., 240) local to various gateways (e.g., 150). Likewise, other functionality of the system manager 205 may also be provided remote from the gateway 150 as a service, such as asset abstraction and binding managers (e.g., 230, 235), application manager 255, among others.

As noted above, asset abstraction can assist not only in easing the deployment of a system and propagating configurations across multiple different systems, but abstraction may also be used to enhance the programming of IoT applications. For instance, development systems may be provided which supplement traditional programming tools (e.g., for use in coding an application) with declarative programming tools allowing users, including novice programmers, to specify generalized or abstracted requirements of the IoT application, expressed as collections of asset taxonomies. Job abstractions may additionally be provided in an abstraction layer logically connected to an asset abstraction layer. A job abstraction layer may facilitate the use declarative programming for encapsulating intentions for a desired IoT system with language design and abstraction layers. This may allow users to specify the “what” (intentions; the cause) and the machine should learn the “how” (procedures; the effect) automatically (e.g., using a system manager 205 accessing and applying the relationships defined in the job and asset abstraction layers). Further, declarative programming tools (e.g., 260) may be provided, which enable IoT application programming based on these job abstractions. Such declarative programming tools may be implemented on a variety of host systems including user devices (e.g., laptops, smartphones, tablet computers, etc.), IoT gateways or other IoT edge devices, cloud computing systems, among other examples. Such tools may enable the “automatic control” by users of various IoT systems.

Continuing with the description of FIG. 2, each of the IoT devices (e.g., 105a, d) may include one or more processors (e.g., 272, 274), one or more memory elements (e.g., 276, 276), and one or more communications modules (e.g., 262, 264) to facilitate their participation in various IoT application deployments. Each device (e.g., 105a, b) can possess unique hardware, sensors (e.g., 110a), actuators (e.g., 115a), and other logic (e.g., 280, 282) to realize the intended function(s) of the device. For instance, devices may be provided with such resources as sensors of varying types (e.g., 110a), actuators (e.g., 115a) of varying types, energy modules (e.g., batteries, solar cells, etc.), computing resources (e.g., through a respective processor and/or software logic), security features, data storage, and other resources.

Turning to FIGS. 3A-3B, simplified block diagrams 300a-b are shown to represent example programming paradigms for programming IoT applications. In traditional solutions, IoT application behaviors are encapsulated by device, with IoT applications programming tuned to addressing the particular capabilities of each specific device. However, device-centric programming can be far from intuitive as the context may be divorced from each individual device's capabilities. As illustrated in FIG. 3A, in traditional programming, users (even lay persons) may be responsible for translating their (declarative) intentions into (imperative) procedures for IOT solutions to execute. As an example, an intent to “increase the living room temperature” will have to be reasoned and translated by the user (e.g., into code) to “turn on a specific heater”. This task may require the user to have an engineering background, limiting the universe of users capable of implementing the system. On the other hand, as represented in FIG. 3B, a declarative programming tool may be provided to facilitate more user-centric programming. User centric programming may be intentional rather than procedural. Specifically, procedures are the effect whereas intentions are the cause. As represented in FIG. 3B, a user-centric declarative intention programming paradigm may be provided that addresses the gap between conventional programming and the average IOT user's abilities, by facilitating programming tools that take as input user's declarative thinking and translates these inputs automatically into procedural descriptions consumable by the IoT devices and system managers used to implement the IoT system.

A declarative programming tool may be provided to build IoT applications according to a layer of ambient abstractions defined to relate sensing and actuation at the level of capabilities. The ambient abstraction layer (or other job abstraction layer) may allow for declarative language design for users to specify high level intentions, with the computer-implemented declarative programming tools utilizing abstraction layer to infer procedures (how) to be applied by sensing/actuating assets from the provided user intentions (what). As noted above, in some implementations, job abstractions may be formulated as ambient abstractions, such that the job relates to realizing and/or maintaining a particular condition using one or more IoT assets (e.g., provided on one or more IoT devices). Indeed, in one example, ambient abstractions may be implanted in a job abstraction (e.g., coupled to an asset abstraction layer) and may define a taxonomy that relates to semantically sensing and actuating to realize a corresponding ambient condition (e.g., within an environment in which IoT devices are or are to be deployed). The ambient abstraction (or other job abstraction) may effectively define a relationship between two or more different asset types (e.g., one or more sensor and/or actuator types), with the relationship being agnostic to the particular radio or communication technologies or protocols used, the manufacturer, model, device identifier, etc. For example, all light sensors (e.g., defined under a light sensor asset abstraction) and all light switches (e.g., defined under a light switch asset abstraction) may be grouped together under a lighting or illuminance ambient abstraction, as the former measures the illuminance and the latter changes the illuminance. Declarative language design allows users to simply express objective—“what” they want, e.g., maintaining the illuminance in the living room to be bright enough for reading, while the declarative programming tool includes sensing/actuating reasoning logic to interpret, from the abstraction layers, the IoT assets to involve the service logic to deploy, among other mechanisms for accomplishing the “how” to achieve an objective (e.g., turning on/off the lights based on the illuminance measured by light sensors in the living room to meet a user's objective), among other examples.

As noted above, a tiered abstraction architecture may be defined (e.g., in abstraction data), which may be utilized by a declarative programming tool to allow users to program new IoT applications using an intentional programming paradigm. In addition to job abstractions, resource (or asset) and capability abstraction layers may be provided. Turning to FIG. 4A, a simplified block diagram 400a is shown representing a simplified example of asset abstraction. A variety of different taxonomies can be defined at varying levels. For instance, a sensor taxonomy can be a parent to a multitude of specific sensor-type taxonomies (e.g., child taxonomies for light sensing, motion sensing, temperature sensing, liquid sensing, noise sensing, etc.), among other examples. In the example of FIG. 4A, an IoT application has been defined to include three asset requirements, represented by taxonomies Motion Sensing 405a, Computation 405b, and Alarm 405c. During asset discovery, a variety of assets (e.g., 408a-f) can be identified as usable by the application (e.g., based on the assets meeting one or more defined discovery conditions). One or more corresponding taxonomies, or abstractions, can be identified (e.g., by an IoT management system) for each of the assets 408a-f. Some of the abstractions may not have relevance to the asset requirements and function of the application, such as an abstraction (e.g., Temperature Sensor and/or HVAC Actuator) determined for thermostat device 408f. Other asset abstractions may match the abstractions (e.g., 405a-c) designated in the IoT application as asset requirements of the application. Indeed, more than one discovered asset may be fit one of the asset requirements. For instance, in the example of FIG. 4A, a PIR sensor 408a and camera 408b are each identified as instances of a motion sensing asset taxonomy 405a. Similarly, a cloud-based computing resource 408c and network gateway 408d are identified as instances of a computation asset taxonomy 405b. In other instances, there may be just a single discovered device satisfying an application asset requirement (e.g., siren 408e of the alarm taxonomy 405c), among other examples.

Conventionally, IoT and wireless sensor network (WSN) applications have been developed to intricately define dataflow among a determined set of physical devices, which involves device-level discovery in development time to obtain and hardcode the corresponding device identifiers and characteristics. By utilizing asset abstraction, development can be facilitated to allow the devices to be discovered and determined at runtime (e.g., at launch of the application), additionally allowing the application to be portable between systems and taxonomy instances. Further, development can be expedited by allowing developers to merely specify asset requirements (e.g., 405a-c), without the necessity to understand radio protocol, network topology, and other technical features.

In one example, taxonomies for asset abstraction can involve such parent taxonomies as sensing assets (e.g., light, presence, temperature sensors, etc.), actuation (e.g., light, HVAC, machine controllers, etc.), power (e.g., battery-powered, landline-powered, solar-powered, etc.), storage (e.g., SD, SSD, cloud storage, etc.), computation (e.g., microcontroller (MCU), central processing unit (CPU), graphical processing (GPU), cloud, etc.), and communication (e.g., Bluetooth, ZigBee, WiFi, Ethernet, etc.), among other potential examples. Discovering which devices possess which capabilities (and belong to which taxonomies) can be performed using varied approaches. For instance, some functions (e.g., sensing, actuating, communication) may be obtained directly from signals received from the device by the system management system via a common descriptive language (e.g., ZigBee's profiles, Bluetooth's profiles and Open Interconnect Consortium's specifications), while other features (e.g., power, storage, computation) may be obtained through deeper queries (utilizing resources on top of the operating system of the queried device), among other examples.

Asset binding can be applied to determine which discovered assets (fitting the asset requirements (abstractions) defined for an application) are to actually be deployed. Criteria can be defined at development time and/or before/at runtime by the application's user, which an IoT system manager (e.g., 205) can consult to perform the binding. For instance, as shown in FIG. 4A, according to the criteria set forth for the application (or for a particular session using the application), one of multiple matching assets for a required taxonomy can be selected. For instance, between PIR sensor 408a and camera 408b, corresponding criteria (e.g., criteria to be applied generally across all taxonomies of the application and/or taxonomies specific to the motion sensing taxonomy 405a) can result in PIR sensor 408a be selected to be deployed to satisfy the motion sensing asset requirement 405a of the application. Similarly, criteria can be assessed to determine that gateway 408d is the better candidate between it and cloud resource 408c to satisfy the application's computation requirement 405b. For asset requirements (e.g., 405c) where only a single discovered instance (e.g., 408e) of the asset taxonomy is discovered, asset binding is straightforward. Those discovered devices (e.g., 408, 408d, 408e) that have been selected, or bound, can then be automatically provisioned with resources from or configured by the IoT system manager (e.g., 205) to deploy the application. Unselected assets (e.g., 408b, 408c, 408f) may remain in the environment, but are unused in the application. In some instances, unselected assets can be identified as alternate asset selections (e.g., in the event of a failure of one of the selected assets), allowing for swift replacement of the asset (deployed with the same settings designated for instances of the corresponding taxonomy).

In some instances, asset binding can be modeled as a bipartite matching (or assignment) problem in which the bipartite graph can be expressed by G=(R,A,E) where R denotes the asset requirements, A denotes the available assets and e=(r,a) in E where a in A is capable of r in R. Note that if R requests for n instances of a particular assets, A′ can be defined as:

$${⋃}_{n} A$$

from which a solution for the (maximum) (weighted) matching problem can be computed. For instance, exhaustive search can be applied as the number of vertices in the bipartite graph are small and the edges are constrained in the sense that there is an edge (r,a) only if a is capable of r.

Turning to the simplified block diagram 400b of FIG. 4B, an example of asset discovery is represented. Asset discovery can allow the scope of available devices to be confined based on discovery conditions or criteria, such as conditions relating to device proximity, room, building, movement state, movement direction, security, permissions, among many other potential (and configurable) conditions. The benefits of such targeted discovery can trickle down to asset binding, as unchecked discovery may return many possible bindings, especially in large scale deployment. For example, in a smart factory, the action of “deploying predictive maintenance” may be ambiguous as there may be hundreds of sensors, motors, alarms, etc. in a factory facility. Asset discovery, in some implementations, takes as input a policy or user input from which a set of discovery criteria can be identified. Upon detecting the universe of assets with which the application could potentially operate, the criteria can be used to constrain the set, in some cases, providing a resulting ordered list of available assets, which can be expressed as f:C×D→D, where C denotes criteria, D denotes a set of devices, and the codomain is a totally ordered set.

For instance, in the example of FIG. 4B, two discovery criteria 415a, 415b are identified for an application. Additional criteria may be defined that is only to apply to some or a specific one of the categories, or taxonomies, of assets, among other examples. Based on the defined criteria 415a-b in this example, the output of discovery according to search criteria A 415a leads to the codomain of a subset of devices in the environment—LS1 (410a), LS2 (410b), GW2 (410g) and LA1 (410h), whereas search criteria B results in LS2 (410b), LS3 (410c), TS1 (410d), HS1 (410e), GW1 (410f), and LA1 (410h). Based on the set of defined discovery criteria (e.g., 415a-b), asset discovery can attempt to reduce the total collection of identified assets to a best solution. Additionally, determining the set of discovered assets for binding consideration can incorporate determining a minimum set of discovered devices, based on the asset requirements of the application. For instance, a minimum set can be selected during discovery such that at least one asset of each required taxonomy is present in the set, if possible. For instance, in the example of FIG. 4B, it can be identified (e.g., by an asset discovery module of the system manager) that application of only criteria B (415b) in discovery yields at least one asset for each of the taxonomies defined for the application.

For instance, the block diagram 400c FIG. 4C illustrates the end-to-end deployment determinations of a system manager for a particular IoT application 450. For instance, based on the discovery conducted in the example of FIG. 4B, a subset of the assets (e.g., LS2 (410b), LS3 (410c), TS1 (410d), HS1 (410e), GW1 (410f), and LA1 (410h)) are “discovered” for potential use by the application (e.g., based on their compliance with criteria B (and the underrepresentation of assets in compliance with criteria)). Accordingly, assets LS1 and GW2 are not to bound to the corresponding IoT application 450 (as indicated by the dashed lines (e.g., 430)), despite each asset being an instance of one of the asset requirements (e.g., Light Sensing, Compute, and Storage) of the application 450.

As noted above, additional criteria can be defined and applied during asset binding. During binding, where the set of discovered assets include more than one instance of a particular required asset taxonomy (e.g., as with assets L2 and L3 in asset taxonomy Light Sensing), criteria can be applied to automatically select the asset that is the better fit for deployment within the IoT system governed, controlled, or otherwise supported by the application 450. Further, as illustrated in FIG. 4C, it is possible for a single asset instance (e.g., GW1) to both belong to two or more taxonomies and to be selected for binding to the application for two or more corresponding asset requirements (e.g., Compute and Storage), as shown. Indeed, a binding criterion can be defined to favor opportunities where multiple asset requirements of the application can be facilitated through a single asset, among other examples.

As represented generally in FIG. 4C, asset discovery can provide the first level for confining the scope of an asset-to-application asset requirement mapping. A user or developer can specify (in some cases, immediately prior to runtime) the asset requirements for a particular application 450, and an environment can be assessed to determine whether assets are available to satisfy these asset requirements. Further, the system manager utility can automatically deploy and provision discovered assets to implement that application, should the requisite combination of assets be found in the environment. Additionally, the system manager utility can automatically apply setting values across the deployed assets in accordance with a configuration defined by a user associated with the application. However, if no instances of one or more of the asset requirements (required taxonomies) are discovered, the application may be determined to be un-deployable within the environment. In such cases, a system manager utility can generate an alert for a user to identify the shortage of requested taxonomy instances, including identifying those taxonomies for which no asset instance was discovered within the environment, among other examples.

Turning FIGS. 5A-5B, devices and asset requirements (e.g., shown in the example of FIG. 4C) may be correspond to resource abstraction (510) and capability abstraction (515) layers defined in an example abstraction layer architecture supporting intentional declarative programming of IoT applications. An additional job abstraction layer (e.g., 505) may be provided that is linked to the capability abstraction layer 515. FIGS. 5A-5B illustrate an example abstraction layer architecture including resource abstractions, capability abstractions, and ambient job abstractions relating to smart or automated office and home solutions. It should be appreciated that abstractions in the abstraction layers 505, 510, 515 may include resource abstractions, capability abstractions, ambient abstractions (and other job abstractions), which may pertain more closely to other use cases, such as agricultural applications, industrial automation, vehicle automation, office automation, smart cities and roads, and so on.

Ambient abstractions may be considered an ontology to relate resources which sense (read) or actuate (manipulate) a particular ambient index. Resource abstractions 510, as noted above, may be utilized to abstract the communication protocols (e.g., ZigBee Home Automation (HA) and Bluetooth Smart (BLE)) used by the particular devices hosting various IoT assets (e.g., sensors, actuators, compute, storage, etc.). Capability abstractions 515 may serve as the intermediate abstraction layer within the architecture and abstract away the particular radio profiles of the devices. For example, within the capability abstraction layer 515, sensors with light sensing capability are treated as fungible instances of the same asset type and are agnostic to the specific radio profiles (e.g., ZigBee, HA, BLE, that might be used). Building upon the resource and capability abstraction layers, the ambient abstraction layer (or another job abstraction) may provide semantically meaningful indexes to relate sensing and actuating with one another for facilitating the supervised reasoning. For example, light sensing is the mechanism for measuring illuminance, whereas light actuating is the mechanism for manipulating illuminance. Accordingly, the taxonomy in the ambient abstraction layer may be referred also as the ambient index.

In the example of FIG. 5A, example ambient abstractions are defined, such as an Illuminance abstraction 505a, Temperature abstraction 505b, Humidity abstraction 505c, Access abstraction 505d, among potentially many other abstractions. Each job subtraction (e.g., 505a-d) may be mapped to one or more capability abstractions (e.g., 515a-f) in the abstraction architecture. The mapping of job abstractions to capability abstractions may be one-to-one, one-to-many, or many-to one. In this example, the Illuminance ambient abstraction 505a can correspond to a job to maintain illumination levels within a particular environment to a particular level. The Illuminance ambient abstraction 505a may define the involvement of assets with capabilities corresponding to one or more capability abstractions. In this example, the Illuminance ambient abstraction 505a defines connections to both Light Sensing 515a and Light Actuating 515f capability abstractions. Through asset discovery, multiple different devices may be discovered that satisfy the Light Sensing and Light Actuating capability abstractions respectively. For instance, light sensors A and B (510a, 510b) and IP camera (510c) may be identified as possessing functionality to satisfy Light Sensing capability abstraction 515a and an automatic light switch 510h and automated window blind control 510i may be identified as assets satisfying the Light Actuating capability abstraction 515f, among other examples.

Other ambient abstractions may be defined according to their respective jobs and corresponding connections may link ambient abstractions to devices discovered within an environment. For instance, a Temperature ambient abstraction 505b may correspond to a job to maintain temperature within an environment and be linked to a Temperature Sensing (515b) and Temperature Actuating (515c) capability abstractions. An example Humidity ambient abstraction 505c to a job to maintain humidity within an environment and be defined to connect to a Moisture Actuating (515dand Moisture Sensing (515e) capability abstractions. An example Access ambient abstraction to 505d may correspond to a job for automating the opening and/or closing of doors, windows, and other closable openings and may be connected to capability abstraction (nots shown in FIG. 5A) such as door open status sensors, door opening actuator, door closing actuators, among other examples.

An example declarative programming tool may facilitate the generation of new IoT applications (or modification of existing IoT applications) by accepting selections of one or more of a collection of available ambient abstractions (defined in a multi-layer abstraction architecture) and generating corresponding instructions to be deployed on real devices discovered in an environment corresponding to the ambient abstractions. For instance, turning to the example illustrated in FIG. 5B, an application 450 may be generated according to declarations (e.g., 520a-c) provided by a user. Each of the declarations (e.g., 520a-d) may correspond to a particular one of the job abstractions (in this example, ambient abstractions) defined within an abstraction architecture. The declarations may identify a particular job abstraction and provide additional parameters to provide context or target attributes for the particular job. For instance, in the particular example of FIG. 5B, one or more declarations (e.g., 520a) may be provided by a user-programmer to define illuminance jobs, one or more additional declarations (e.g., 520b) may be provided by the user to define one or more ambient temperature jobs, and the user may further provide declarations (e.g., 520c) corresponding to one or more ambient humidity jobs, among other examples. In this example, no declarations (e.g., 520d) are provided corresponding to some of the available job abstractions defined in the abstraction architecture (e.g., Access abstraction 505d. Indeed, a variety of customized IoT applications may be provided according to the job abstractions defined in an abstraction architecture according to the specific intents of the particular user.

In one example, an IoT application or program (P) may be defined from a set of one or more declarations (D). Each declaration D may adopt a syntax according to a tuple of (F, Z, T, S, U), where F is an ambient index identifying a particular one of the ambient job abstractions defined in the architecture and Z represents a comfort zone value for the ambient index and defines a closed or open set of values corresponding to an ambient condition to be maintained for the ambient index. For instance, a comfort factor within a temperature ambient index (corresponding to a Temperature ambient abstraction 505b) may be a range between 72 and 78 degrees Fahrenheit, among other examples. A declaration tuple may further define a time parameter (T) specifying when (e.g., between 9 am and 5 pm, among other examples) automatic control of the corresponding comfort factor and comfort zone (i.e., defined in the same declaration) should take effect, a location parameter (L) specifying where within a particular environment (e.g., within particular coordinates, within a semantic location (e.g., a particular room), etc.) automatic control of the corresponding comfort factor and comfort zone of the declaration should take effect, and a user parameter (U) may specify an individual, group, or class of users to whom the corresponding comfort factor and comfort zone of the declaration should apply (e.g., to differentiate between users in a multi-user environment and apply corresponding comfort factor and comfort zone when a corresponding user is detected as being present within the location (represented by L) (e.g., based on voice recognition captured by a microphone asset, facial recognition captured by a camera asset, etc.). In other examples, additional (or alternative) declaration parameters may be defined and the parameters may be extended, for instance, to include such examples as season, time zone, power source, etc.

In one example, declarations, such as introduced above, may serve as the inputs provided by a user to program an IoT application (e.g., 450). For instance, a user may identify a variety of functional results the user desires for an IoT system. As examples, a respective declaration may be defined by the user for one or more different ambient illuminance conditions to be implemented by IoT devices within a particular environment. For instance, a first declaration could be defined to indicate that a brightness level (indicated by the selection of an Illuminance abstraction in declaration parameter F) of between 250 and 350 lumens (defined in declaration parameter Z) be maintained between 9 am and 5 pm (defined in declaration parameter T) within a room designated as an office (defined declaration parameter L) for a particular user (defined in declaration parameter U). Additional declarations may also be defined to indicate other lighting conditions to be applied during different dates or times of day (e.g., within the same location and for the same user), in different locations within the environment (e.g., different rooms within the same home), for different users or groups of users (e.g., with different conditions be applied according to different users' preferences). Accordingly, to define an array of different lighting conditions that a user wishes to have implemented in an environment, the user may define a corresponding declaration (e.g., 520a). Likewise, various declarations (e.g., 520b, 520c) may be further defined to implement a collection of different temperature and humidity conditions within an environment.

Turning to the example shown in the simplified block diagram 600 in FIG. 6, a user 605 may define a collection of declarations (e.g., 520) through a declarative programming tool 260. For instance, a user may utilize a graphical, speech, gesture, or other interface provided by the declarative programming tool 260 to generate or modify an IoT application. The declarative programming tool 260 may take the defined declarations 520 as inputs and automatically generate (i.e., without further user engineering or reasoning) data (e.g., 610) defining a dataflow and/or rules to be applied in an IoT system to implement the ambient conditions defined in the declarations 520. In the example shown in FIG. 6, the data 610 may be may be implemented in a macro expansion manner, shown in the pseudocode illustrated in FIG. 6 in which C is the context (the current situation) comprising time (t), location (l), sensor reading (s) and actuator state (a). Note that this example shows one potential non-limiting implementation for certain types of numeric sensor readings and binary actuation states. Accordingly, it should be appreciated that these principles may be likewise generalized for other, alternate (and more complex) types of sensor readings and actuation states, among other examples.

Data 610 generated by the declarative programming tool 260 may include code or other data parsable or executable by a system manager (e.g., 205) for use in deploying an IoT system that implements the desired behaviors identified in the declarations 520. The data 610 may be provided for use according to an abstraction architecture that incorporates capability abstractions, allowing the system manager 250 to flexibly identify and deploy the IoT application within one or more physical environments and/or using varied combinations of IoT devices (e.g., 105a-c). To illustrate, returning to the example of FIG. 5B, a system manager may receive data generated from declarations based on a particular subset of job abstractions (e.g., 505a-c) defined in an example abstraction architecture. The system manager may identify sets of capability abstractions that correspond with or are linked to each of the subset of job abstractions and may identify, using the capability abstractions, assets within a particular environment that may be used to implement the IoT application. For instance, the system manager may discover assets 510a-c and determine that these assets may be utilized to implement at least one of the declarations 520a related to an Illuminance ambient abstraction 505a defined in the application 450. The system manager may then select one or more of these capable of assets (e.g., 510b) for use in implementing a portion of the illuminance job and select one or more additional assets (e.g., 510h and 510i) to implement the job. In some cases, the system manager may push service logic and capability data to the selected assets in order to implement the application 450. In other instances, the rules defined for the declarations (e.g., in data 610) may be enforced at the system manager, for instance, with the system manager receiving data generated by various sensor assets (e.g., 510b) and sending commands to other assets (e.g., actuator assets 510h-i) based on the received data and whether they satisfy the rules defined in the application 450, among other examples.

Returning to the example of FIG. 6, a declarative programming tool 260 may additionally allow adjustments to be made to existing IoT applications. For instance, new or revised declarations may be defined by a user and added to supplement or replace declarations defined in connection with the original generation of an IoT application. Further, declarations may be deleted from an existing IoT application using user interfaces o the declarative programming tool 260. In some instances, modification to an IoT application may be made after (and even during) deployment of an IoT application. In such cases, updated data (e.g., 610) may be generated by a declarative programming tool 260 in response to new or modified declarations to instruct the system manager 205 to update rules, configurations, and/or service logic utilized in the deployment. Revised declarations serving to modify an IoT application may additionally result in the use of additional or substitute IoT devices (e.g., IoT devices in a location identified in a new or modified declaration). Modifications to an IoT application may include new declarations or changes to parameters of existing declarations, among other examples.

A system manager 205, such as a system manager implemented in an IoT gateway device, may be configured to deploy various instances of the same IoT application or of different IoT applications within one or more environments. Service logic (and the services provided through its execution) may define interactions between devices and the actions that are to be performed through the IoT application's deployment. The service logic may identify the assets required or desired within the deployment and may identify the same by asset abstraction. Further, interactions or relationships between the devices may also be defined, with these definitions, too, being made by reference to respective asset abstractions. Accordingly, the service logic can define the set of devices (or device types) that is to be discovered by the gateway and drive the discovery and binding processes used to identify and select a set of devices (e.g., 105a-c) to be used in the deployment.

In some examples, the service logic may be carried out locally by the system manager. In some cases, the service can be implemented as a script and be utilized to trigger events and actions utilizing the deployed devices. As noted above, the service logic may also identify conditions where outside computing resources, such as a system hosting remote service logic is to be called upon, for instance, to assist in processing data returned by sensors in IoT application deployment. Service logic may be generated by the declarative programming tool (e.g., in response to receiving a set of declarations) or may be generated by a service manager in response to receiving data (e.g., 610) generated by the declarative programming tool from a user's declarations. Services (performed locally or remotely through corresponding service logic) may include the receiving of inputs, such as sensor readings, static values or actuator triggers, functions, processes, and calculations to be applied to the inputs, and outputs generated based on the function results, which may in turn specify certain actions to be performed by an actuator or results to be presented on a user device, among other examples. In some cases, portions of service logic may be distributed to computing resources, or assets, within the deployed IoT application, and a portion of the input processing and result generation for a deployment may be performed by computation assets on the deployed devices (e.g., 105a-c) themselves. Such results may in turn be routed through or returned to the gateway for further processing (e.g., by service logic local to the gateway or by service logic executed on a cloud-based backend system, etc.).

Service deployment may begin by identifying a set of asset abstractions mapped to requirements of the IoT application. Identification of these abstractions may prompt initiation of an asset discovery stage. During discovery devices within communication range of a system manager may be discovered together with identifier information of each device to allow the system manager to determine which asset abstraction(s) may be mapped to each device (with its respective collection of assets). Location information may also be determined for the various devices discovered in the environment. In some cases, the devices (e.g., 105a-c) upon being connected to a network and the system manager may advertise or be assigned a location tag. In some cases, device discovery may include determining (e.g., from global positioning, signal strength, photographic data, or other localization data) the location, within an environment, of the devices. In the event that more assets of a particular type are identified within the location than are needed, the gateway can additional perform a binding analysis (according to one or more binding criteria) to select which device(s) to bind to one or more corresponding asset abstractions.

With the set of devices selected for a corresponding IoT application deployment, automated configuration of the devices may be performed by the system manager. Configuration data may embody a configuration that identifies one or more static settings relevant to a particular device to which the configuration is being applied. Multiple configurations may be provided for use in provisioning multiple different types of devices in a given deployment. Various configuration data in data stores may describe multiple, different preset configurations, each tailored to a specific scenario or deployment. In a particular deployment, configuration data may be provided for each asset abstraction, or taxonomy, to be included in a corresponding IoT application (e.g., programmed according to the asset abstractions). Configuration data may be provided in a standard format, such as XML, JSON or CBOR file, among other examples.

With the configuration data provided to the discovered devices (e.g., 105a-c) initial deployment may be considered complete and devices (e.g., 105a-c) and their respective assets (e.g., individual sensors and actuators hosted on the devices) may operate in accordance with the configurations provided them. Accordingly, during runtime, sensing messages may be sent up to the system manager 205 from the devices (e.g., 105a-c). The system manager 205 can receive the sensing messages and utilize service logic either local to or remote from the system manager 205 to process the sensor data as inputs. In cases where multiple sensors are producing sensor data according to a particular declaration of the IoT application, service logic (e.g., executed on the system manager 205 receiving and aggregating this data) may be used to determine a current ambient level from the combined sensor data (e.g., an average, maximum, minimum, median, etc.). Likewise, multiple actuators may be deployed to implement the job described in a particular declaration (e.g., both an light bulb controlled by an automated light switch and sunlight from an automated window blind control) and service logic may be utilized to balance (e.g., through iterative adjustments, machine learning, or other techniques) the combined activity driven by the multiple actuators to achieve the desired ambient “comfort zone,” among other examples. One or more results may be generated from the processing and used as the basis of actuating messages sent from the system manager 205 to other devices implementing corresponding actuators (e.g., 105a-c) or backend or cloud-based services supplementing or supporting the operation of the deployed IoT system (for further processing, from which additional or alternative actuator instructions may be derived and sent), among other examples.

It should be appreciated that the examples presented above are provided for illustration purposes only and represent only a portion of potentially limitless example IoT applications that may developed using intentional declarative programming and deployed automatically in a location. It should be further appreciated that potentially any collection of devices (e.g., and not simply end user mobile devices) may be discovered and utilized in deployment of an IoT application (including diverse collections of devices of multiple different types). Indeed, asset abstraction allows for extensive flexibility in allowing such deployments and automated configurations.

Turning to FIG. 7, as noted above, an application developed according to the principles of job and asset abstraction, as described herein, can allow a given IoT application to be programmed and deployed in a number of locations employing varied collections of IoT devices and assets. Further, configurations can be provided to determine characteristics of a particular deployment of the IoT application. In some cases, different configurations can be employed in different deployments of the same IoT applications, leading potentially, to different outcomes in each deployment (including in deployments that are otherwise identical (e.g., using the same combination of IoT devices in a comparable environment)). In other cases, the same configurations can be employed in distinct deployments that utilize different combinations of devices (e.g., different devices bound to at least some of the defined abstractions of the IoT application) to yield comparable outcomes, even when the devices used are not identical.

As an example, a user can program a particular IoT application through the definition of a collection of declarations corresponding to job abstractions defined in a multi-layer abstraction architecture. The particular IoT application may be reusable, in the sense that it may be deployed in multiple different environment using potentially varied collections of IoT devices. For instance, as shown in the example illustrated by the simplified block diagram 700 of FIG. 7, in a first environment 705, a first gateway 150a can be utilized to deploy a first instance of the particular IoT application. A copy of the IoT application 450, defined using a set of job abstractions 715 (e.g., such as a collection of ambient abstractions), may be on a local gateway 150a and/or remotely by an application server or other system(s) providing cloud resources (e.g., 720). In one example, a smartphone 130 (or other device) may enter the first environment 705 and communicate with a corresponding gateway 150a to indicate that the particular IoT application 450 is to be deployed in the first environment 705. For instance, the gateway 150a may deploy the IoT application 450 in the first environment 705 by discovering a set of assets A1, A2, B1, C1, D1, D2 that meet the capabilities mapped to job abstractions in the job abstraction set 715 of the particular IoT application (e.g., where assets A1 and A2 are instances of capability taxonomy A, asset B1 is an instance of capability taxonomy B, and so on). The IoT application, in this example, may have asset requirements mapped to the job abstractions 715 corresponding to taxonomies A, B, C, D, and E. Asset binding can be performed, resulting in assets A1, B1, C1, D1 and E1 being selected and deployed for the instance of the IoT application deployment in Environment A 705. Additionally, a particular set of configurations may be pushed to the selected assets (A1, B1, C1, D1, E1) for use in the deployment. In some examples, the use of this particular set of configurations may be based on a request of a user or even the identification (e.g., by the gateway) that a particular user device associated with a user is present in Environment A 705. Accordingly, the gateway can configure an IoT application's particular deployment based on the preferences of a user within the environment, a property owner (e.g., a manager or owner of the environment), according to government or corporate regulations, among other examples.

In another, remote environment, Environment B (710), an instance of the same particular IoT application 450 may be deployed by another gateway 150b in the other environment 710. A different set of assets may be discovered in Environment B 710 than was used in Environment A 705, resulting in a different set of deployed assets (e.g., A2, B2, C2, D1, and E1) for the IoT application in Environment B 710. Some of the assets in Environment B may be instances of the same asset (e.g., the same device model) discovered in Environment A (e.g., A2, C1, D1). Some assets may not be strongly tied to location, such as assets on a mobile device (e.g., 130) that may be used in both the IoT application deployments in Environments A and B. Despite the deployments being different between the two environments (e.g., 705, 710), when viewed at the asset abstraction level, the deployments may be functional equivalents. Further, the settings utilized in each deployment can be applied equally within each environment 705, 710 by providing the same configurations or different configuration to each of the respective IoT application deployments. While, in practice, the resulting systems may not be functionally identical (as differences in sensitivities between the asset instances (e.g., B1 and B2) may manifest), implementations of the application in varied environments can be at least approximated with minimal effort of the user.

In some cases, an IoT application generated by a particular user may be shared by the particular user for adoption by other users. For instance, a copy of an application 450 generated from a selection of a set of job abstractions (and definition of corresponding declarations) may be uploaded to and hosted in a cloud-based or other storage system (e.g., 720) which may be potentially accessed by multiple different gateways at the direction of potentially multiple different users. In some cases, a particular user-authored IoT application can be private to a particular user or group of users. In other cases, user-authored IoT applications may be more widely shared and accessible. Through the sharing of user-authored IoT applications, users may identify and review previously-generated IoT applications and have them apply to their particular systems, allowing the user to quickly identify IoT applications solutions rather than “reinventing the wheel,” among other examples.

While some of the systems and solution described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

FIG. 8 is a simplified flowchart 800 illustrating example technique for generating an IoT application using declarative programming. A user input may be received 805 via a user interface of a programming tool, with the input identifying a subset of job abstractions defined in a layered abstraction architecture. Each job abstraction corresponds to an abstraction of a job performable by a collection of assets in an IoT system. Some of the job abstractions in the subset may be ambient abstractions that correspond to jobs with the goal of maintaining a particular ambient condition within a physical environment. The user input may further define parameters to define the what, where, and when of the corresponding job(s). Each job abstraction may be mapped to two or more capability abstractions defined in the layered abstraction architecture. Capability abstractions may correspond to particular capabilities, which may be possessed by assets hosted on a device. For instance, capability abstractions may include various types of sensors, various types of actuators, among other asset types. The specific capability abstractions mapped to the subset of job abstractions may be identified 810 to identify the types of assets that would be used to implement each of the respective jobs identified through the user's selection of corresponding job abstractions. Program data may be generated 815 by the programming tool based on the user input and the layered abstraction architecture. Particular patterns of data flows and rules may be defined for each of the job abstractions and these data flows and/or rules may be embodied in the program data (parsable and/or executable by the IoT system that is to implement the specified jobs). The program data may be further refined from job-specific parameters (e.g., location parameters, time parameters, value range (or “comfort zone”) parameters, user parameters, etc.). The program data generated 815 by the programming tool may be usable (e.g., by an IoT system manager process, IoT gateway, or other IoT system elements) to cause a set of devices in an environment to operate together to realize the specified job (i.e., corresponding to the intent expressed in the received user input (at 805)).

A system manager, implemented using one or more computing devices, may access and process the program data to implement an IoT application involving a set of devices in an environment. In some cases, the programming tool and system manager may be hosted on the same system. In other instances, the programming tool and system manager may be separate and distinct systems, hosted on separate computing devices, among other example implementations. In the example of FIG. 8, a system manager may discover the presence of various devices within a network. The discovery of the devices may further allow the system manager to identify the respective assets (e.g., compute assets, memory assets, sensor assets, actuator assets, etc.) on the devices. The system manager may utilize the generated program data to determine 825 which of these discovered assets to use to implement the jobs described in the declarations received from the user (at 805). For instance, the system manager may identify that certain discovered assets are asset types corresponding to the capability abstractions mapped to the job abstractions of the program data. As an example, the system manager may process the program data to determine that a number of instances of various types of assets are needed to implement various jobs (e.g., depending on the specific parameters defined by the user for the job in the corresponding declaration). The system manager may then determine 830 data flows and/or rules to be applied in the determined set of assets (at 825) and even push service logic and/or configuration data to one or more of the set of assets to launch 830 the IoT application developed by the programming tool based on the received user inputs. The launched IoT application may utilize the set of assets to perform the job(s) communicated by the user through the user inputs.

FIGS. 9-10 are block diagrams of exemplary computer architectures that may be used in accordance with embodiments disclosed herein. Other computer architecture designs known in the art for processors and computing systems may also be used. Generally, suitable computer architectures for embodiments disclosed herein can include, but are not limited to, configurations illustrated in FIGS. 9-10.

FIG. 9 is an example illustration of a processor according to an embodiment. Processor 900 is an example of a type of hardware device that can be used in connection with the implementations above. Processor 900 may be any type of processor, such as a microprocessor, an embedded processor, a digital signal processor (DSP), a network processor, a multi-core processor, a single core processor, or other device to execute code. Although only one processor 900 is illustrated in FIG. 9, a processing element may alternatively include more than one of processor 900 illustrated in FIG. 9. Processor 900 may be a single-threaded core or, for at least one embodiment, the processor 900 may be multi-threaded in that it may include more than one hardware thread context (or “logical processor”) per core.

FIG. 9 also illustrates a memory 902 coupled to processor 900 in accordance with an embodiment. Memory 902 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 900 can execute any type of instructions associated with algorithms, processes, or operations detailed herein. Generally, processor 900 can transform an element or an article (e.g., data) from one state or thing to another state or thing.

Code 904, which may be one or more instructions to be executed by processor 900, may be stored in memory 902, or may be stored in software, hardware, firmware, or any suitable combination thereof, or in any other internal or external component, device, element, or object where appropriate and based on particular needs. In one example, processor 900 can follow a program sequence of instructions indicated by code 904. Each instruction enters a front-end logic 906 and is processed by one or more decoders 908. The decoder may generate, as its output, a micro operation such as a fixed width micro operation in a predefined format, or may generate other instructions, microinstructions, or control signals that reflect the original code instruction. Front-end logic 906 also includes register renaming logic 910 and scheduling logic 912, which generally allocate resources and queue the operation corresponding to the instruction for execution.

Processor 900 can also include execution logic 914 having a set of execution units 916a, 916b, 916n, etc. Some embodiments may include a number of execution units dedicated to specific functions or sets of functions. Other embodiments may include only one execution unit or one execution unit that can perform a particular function. Execution logic 914 performs the operations specified by code instructions.

After completion of execution of the operations specified by the code instructions, back-end logic 918 can retire the instructions of code 904. In one embodiment, processor 900 allows out of order execution but requires in order retirement of instructions. Retirement logic 920 may take a variety of known forms (e.g., re-order buffers or the like). In this manner, processor 900 is transformed during execution of code 904, at least in terms of the output generated by the decoder, hardware registers and tables utilized by register renaming logic 910, and any registers (not shown) modified by execution logic 914.

Although not shown in FIG. 9, a processing element may include other elements on a chip with processor 900. For example, a processing element may include memory control logic along with processor 900. The processing element may include I/O control logic and/or may include I/O control logic integrated with memory control logic. The processing element may also include one or more caches. In some embodiments, non-volatile memory (such as flash memory or fuses) may also be included on the chip with processor 900.

FIG. 10 illustrates a computing system 1000 that is arranged in a point-to-point (PtP) configuration according to an embodiment. In particular, FIG. 10 shows a system where processors, memory, and input/output devices are interconnected by a number of point-to-point interfaces. Generally, one or more of the computing systems described herein may be configured in the same or similar manner as computing system 1000.

Processors 1070 and 1080 may also each include integrated memory controller logic (MC) 1072 and 1082 to communicate with memory elements 1032 and 1034. In alternative embodiments, memory controller logic 1072 and 1082 may be discrete logic separate from processors 1070 and 1080. Memory elements 1032 and/or 1034 may store various data to be used by processors 1070 and 1080 in achieving operations and functionality outlined herein.

Processors 1070 and 1080 may be any type of processor, such as those discussed in connection with other figures. Processors 1070 and 1080 may exchange data via a point-to-point (PtP) interface 1050 using point-to-point interface circuits 1078 and 1088, respectively. Processors 1070 and 1080 may each exchange data with a chipset 1090 via individual point-to-point interfaces 1052 and 1054 using point-to-point interface circuits 1076, 1086, 1094, and 1098. Chipset 1090 may also exchange data with a high-performance graphics circuit 1038 via a high-performance graphics interface 1039, using an interface circuit 1092, which could be a PtP interface circuit. In alternative embodiments, any or all of the PtP links illustrated in FIG. 10 could be implemented as a multi-drop bus rather than a PtP link.

Chipset 1090 may be in communication with a bus 1020 via an interface circuit 1096. Bus 1020 may have one or more devices that communicate over it, such as a bus bridge 1018 and I/O devices 1016. Via a bus 1010, bus bridge 1018 may be in communication with other devices such as a user interface 1012 (such as a keyboard, mouse, touchscreen, or other input devices), communication devices 1026 (such as modems, network interface devices, or other types of communication devices that may communicate through a computer network 1060), audio I/O devices 1014, and/or a data storage device 1028. Data storage device 1028 may store code 1030, which may be executed by processors 1070 and/or 1080. In alternative dembodiments, any portions of the bus architectures could be implemented with one or more PtP links.

The computer system depicted in FIG. 10 is a schematic illustration of an embodiment of a computing system that may be utilized to implement various embodiments discussed herein. It will be appreciated that various components of the system depicted in FIG. 9 may be combined in a system-on-a-chip (SoC) architecture or in any other suitable configuration capable of achieving the functionality and features of examples and implementations provided herein.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

In general, one aspect of the subject matter described in this specification can be embodied in methods and executed instructions that include or cause the actions of identifying a sample that includes software code, generating a control flow graph for each of a plurality of functions included in the sample, and identifying, in each of the functions, features corresponding to instances of a set of control flow fragment types. The identified features can be used to generate a feature set for the sample from the identified features

These and other embodiments can each optionally include one or more of the following features. The features identified for each of the functions can be combined to generate a consolidated string for the sample and the feature set can be generated from the consolidated string. A string can be generated for each of the functions, each string describing the respective features identified for the function. Combining the features can include identifying a call in a particular one of the plurality of functions to another one of the plurality of functions and replacing a portion of the string of the particular function referencing the other function with contents of the string of the other function. Identifying the features can include abstracting each of the strings of the functions such that only features of the set of control flow fragment types are described in the strings. The set of control flow fragment types can include memory accesses by the function and function calls by the function. Identifying the features can include identifying instances of memory accesses by each of the functions and identifying instances of function calls by each of the functions. The feature set can identify each of the features identified for each of the functions. The feature set can be an n-graph.

Further, these and other embodiments can each optionally include one or more of the following features. The feature set can be provided for use in classifying the sample. For instance, classifying the sample can include clustering the sample with other samples based on corresponding features of the samples. Classifying the sample can further include determining a set of features relevant to a cluster of samples. Classifying the sample can also include determining whether to classify the sample as malware and/or determining whether the sample is likely one of one or more families of malware. Identifying the features can include abstracting each of the control flow graphs such that only features of the set of control flow fragment types are described in the control flow graphs. A plurality of samples can be received, including the sample. In some cases, the plurality of samples can be received from a plurality of sources. The feature set can identify a subset of features identified in the control flow graphs of the functions of the sample. The subset of features can correspond to memory accesses and function calls in the sample code.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The following examples pertain to embodiments in accordance with this Specification. Example 1 includes a machine accessible storage medium having instructions stored thereon, that, when executed on a machine, cause the machine to: receive at least one user input including an identification of a set of job abstractions, where each job abstraction in the set of job abstractions includes a respective one of a plurality of defined job abstractions and each of the plurality of defined job abstractions are mapped to two or more asset capability abstractions in a plurality of defined asset capability abstractions; and process the user input to generate program data, based on the set of job abstractions. The resulting program data is executable by a processor device to: identify a set of asset capability abstractions in the plurality of asset capability abstractions corresponding to the set of job abstractions; determine that a set of devices in an environment possess capabilities corresponding to the set of asset capability abstractions; and launch a system including the set of devices to implement jobs corresponding to the set of job abstractions.

Example 2 may include the subject matter of example 1, where the at least one user input includes a declaration received through a user interface, and the declaration includes an identification of at least a particular one of the set of job abstractions and one or more parameters for a particular job corresponding to the particular job abstraction.

Example 3 may include the subject matter of example 2, where the user input includes a plurality of declarations and each one of the plurality of declarations corresponds to a respective job.

Example 4 may include the subject matter of example 3, where the set of job abstractions includes an ambient abstraction, a particular one of the declarations corresponds to the ambient abstraction, and the particular job includes maintaining a type of ambient condition according to the parameters of the particular declaration.

Example 5 may include the subject matter of example 4, where the type of ambient condition is one of a plurality of ambient condition types, the plurality of asset capability abstractions include a respective capability abstraction corresponding to each one of the plurality of ambient condition types.

Example 6 may include the subject matter of example 5, where the plurality of ambient condition types include an illuminance, temperature, humidity, and access, and the plurality of job abstractions includes an illuminance ambient abstraction corresponding to the illuminance ambient condition type, a temperature ambient abstraction corresponding to the temperature ambient condition type, a humidity ambient abstraction corresponding to the humidity ambient condition type, and an access ambient abstraction corresponding to the access ambient condition type.

Example 7 may include the subject matter of any one of examples 4-6, where the parameters include a value parameter to identify a level at which the corresponding ambient condition is to be maintained.

Example 8 may include the subject matter of example 7, where the parameters further include a location parameter identifying a location within a physical environment in which the corresponding ambient condition is to be maintained.

Example 9 may include the subject matter of any one of examples 7-8, where the parameters further include a time parameter identifying a time window in which the corresponding ambient condition is to be maintained.

Example 10 may include the subject matter of any one of examples 7-9, where the parameters further include a user parameter identifying one or more users for which the corresponding ambient condition is to be maintained.

Example 11 may include the subject matter of any one of examples 2-10, where the declaration includes a tuple.

Example 12 may include the subject matter of any one of examples 1-11, where the two or more asset capability abstractions include at least one sensor-type asset capability abstraction and at least one actuator-type asset capability abstraction.

Example 13 may include the subject matter of any one of examples 1-12, where the user input is received through a declarative programming tool.

Example 14 may include the subject matter of example 13, where the program data includes at least a portion of an Internet of Things (IoT) application developed using the declarative programming tool.

Example 15 may include the subject matter of example 14, where the program data is for use in launching instances of the IoT application in any one of a plurality of environments using any one of a plurality of different sets of devices.

Example 16 may include the subject matter of any one of examples 1-16, where the set of job abstractions includes two or more job abstractions and the resulting IoT application is capable of directing the system to perform a plurality of jobs corresponding to the two or more job abstractions.

Example 17 is a method including: receiving at least one user input including an identification of a set of job abstractions, where each job abstraction in the set of job abstractions includes a respective one of a plurality of defined job abstractions and each of the plurality of defined job abstractions is mapped to two or more asset capability abstractions in a plurality of defined asset capability abstractions; and processing the user input to generate program data, based on the set of job abstractions. The resulting program data may be executable by a machine to: determine a set of asset capability abstractions in the plurality of asset capability abstractions corresponding to the set of job abstractions; determine that a set of devices in an environment possess capabilities corresponding to the set of asset capability abstractions; and launch a system including the set of devices to implement jobs corresponding to the set of job abstractions.

Example 18 may include the subject matter of example 17, where the at least one user input includes a declaration received through a user interface, and the declaration includes an identification of at least a particular one of the set of job abstractions and one or more parameters for a particular job corresponding to the particular job abstraction.

Example 19 may include the subject matter of example 18, where the user input includes a plurality of declarations and each one of the plurality of declarations corresponds to a respective job.

Example 20 may include the subject matter of example 19, where the set of job abstractions includes an ambient abstraction, a particular one of the declarations corresponds to the ambient abstraction, and the particular job includes maintaining a type of ambient condition according to the parameters of the particular declaration.

Example 21 may include the subject matter of example 20, where the type of ambient condition is one of a plurality of ambient condition types, the plurality of asset capability abstractions include a respective capability abstraction corresponding to each one of the plurality of ambient condition types.

Example 22 may include the subject matter of example 21, where the plurality of ambient condition types include an illuminance, temperature, humidity, and access, and the plurality of job abstractions includes an illuminance ambient abstraction corresponding to the illuminance ambient condition type, a temperature ambient abstraction corresponding to the temperature ambient condition type, a humidity ambient abstraction corresponding to the humidity ambient condition type, and an access ambient abstraction corresponding to the access ambient condition type.

Example 23 may include the subject matter of any one of examples 20-22, where the parameters include a value parameter to identify a level at which the corresponding ambient condition is to be maintained.

Example 24 may include the subject matter of example 23, where the parameters further include a location parameter identifying a location within a physical environment in which the corresponding ambient condition is to be maintained.

Example 25 may include the subject matter of any one of examples 23-24, where the parameters further include a time parameter identifying a time window in which the corresponding ambient condition is to be maintained.

Example 26 may include the subject matter of any one of examples 23-25, where the parameters further include a user parameter identifying one or more users for which the corresponding ambient condition is to be maintained.

Example 27 may include the subject matter of any one of examples 18-26, where the declaration includes a tuple.

Example 28 may include the subject matter of any one of examples 17-27, where the two or more asset capability abstractions include at least one sensor-type asset capability abstraction and at least one actuator-type asset capability abstraction.

Example 29 may include the subject matter of any one of examples 17-28, where the user input is received through a declarative programming tool.

Example 30 may include the subject matter of example 29, where the program data includes at least a portion of an Internet of Things (IoT) application developed using the declarative programming tool.

Example 31 may include the subject matter of example 30, where the program data is for use in launching instances of the IoT application in any one of a plurality of environments using any one of a plurality of different sets of devices.

Example 32 may include the subject matter of any one of examples 17-31, where the set of job abstractions includes two or more job abstractions and the resulting IoT application is capable of directing the system to perform a plurality of jobs corresponding to the two or more job abstractions.

Example 33 is a system including means to perform the method of any one of examples 17-32.

Example 34 is a system including one or more processor devices; one or more memory elements; and a declarative programming tool. The declarative programming tool is executable by the one or more processor devices, to receive, through a user interface, a set of declarations, where each declaration in the set of declarations identifies a respective one of a plurality of ambient abstractions, each ambient abstraction is mapped to two or more asset capability abstractions in a plurality of defined asset capability abstractions and corresponds to a job to maintain an ambient condition within an environment using a system, and each declaration in the set of declarations further identifies respective parameters for a corresponding job defined by the declaration; determine a set of asset capability abstractions corresponding to the ambient abstractions identified in the set of declarations; and generate program data, from the declarations, executable to implement a system including one or more devices with capabilities corresponding to capabilities represented by the set of asset capability abstractions, where the system is to perform the jobs defined in the set of declarations.

Example 35 may include the subject matter of example 34, where the system further includes a system manager executable by one or more processor devices to: receive the program data generated by the declaration programming tool; discovery a plurality of assets within the environment, where the plurality of assets are hosted on one or more devices; determine that each of the plurality of assets corresponds to one or more of the set of asset capabilities; and cause implementation of the jobs defined in the set of declarations using the plurality of assets.

Example 35 may include the subject matter of example 35, where the system manager is to determine that a particular sensor asset in the plurality of assets and a particular actuator asset in the plurality of assets are to implement a job corresponding to a particular one of the set of declarations, where the particular actuator is to actuate based on sensor data generated by the particular sensor asset according to parameters of the particular declaration.

Example 36 may include the subject matter of example 36, where the system manager is to: receive the sensor data from the particular sensor asset; process the sensor data based on the parameters of the particular declaration to generate an actuator instruction; and send the actuator instruction to the particular actuator asset based on the particular declaration.

Example 37 may include the subject matter of example 35, further including a gateway device to communicate with the one or more devices, where the system manager is implemented on the gateway device.

Example 38 may include the subject matter of example 35, where the system manager includes the declarative programming tool.

Example 39 may include the subject matter of example 34, where the parameters include a value parameter to identify a level at which the corresponding ambient condition is to be maintained, a location parameter identifying a location within the environment in which the corresponding ambient condition is to be maintained, and a time parameter identifying a time window in which the corresponding ambient condition is to be maintained.

Example 40 may include the subject matter of example 34, where each ambient abstraction represents a respective one of a plurality of ambient condition types.

Example 41 may include the subject matter of example 40, where the plurality of ambient condition types include an illuminance, temperature, humidity, and access, and the plurality of job abstractions includes an illuminance ambient abstraction corresponding to the illuminance ambient condition type, a temperature ambient abstraction corresponding to the temperature ambient condition type, a humidity ambient abstraction corresponding to the humidity ambient condition type, and an access ambient abstraction corresponding to the access ambient condition type.

Example 42 may include the subject matter of any one of examples 34-41, where the declaration includes a tuple.

Example 43 may include the subject matter of any one of examples 34-42, where the two or more asset capability abstractions include at least one sensor-type asset capability abstraction and at least one actuator-type asset capability abstraction.

Example 44 may include the subject matter of any one of examples 34-43, where the program data includes at least a portion of an Internet of Things (IoT) application developed using the declarative programming tool.

Example 45 may include the subject matter of example 44, where the program data is for use in launching instances of the IoT application in any one of a plurality of environments using any one of a plurality of different sets of devices

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1. At least one machine accessible storage medium having instructions stored thereon, wherein the instructions, when executed on a machine, causes the machine to:
receive at least one user input comprising an identification of a set of job abstractions, wherein each job abstraction in the set of job abstractions comprises a respective one of a plurality of defined job abstractions and each of the plurality of defined job abstractions are mapped to two or more asset capability abstractions in a plurality of defined asset capability abstractions; and
process the user input to generate data, based on the set of job abstractions, wherein the data are executable by a processor device to:
determine a set of asset capability abstractions in the plurality of asset capability abstractions corresponding to the set of job abstractions;
determine that a set of devices in an environment possess capabilities corresponding to the set of asset capability abstractions; and
launch a system comprising the set of devices to implement jobs corresponding to the set of job abstractions.

2. The storage medium of claim 1, wherein the at least one user input comprises a declaration received through a user interface, and the declaration comprises an identification of at least a particular one of the set of job abstractions and one or more parameters for the particular job.

3. The storage medium of claim 2, wherein the user input comprises a plurality of declarations and each one of the plurality of declarations corresponds to a respective job.

4. The storage medium of claim 3, wherein the set of job abstractions comprises an ambient abstraction, a particular one of the declarations corresponds to the ambient abstraction, and the job comprises maintaining a type of ambient condition according to the parameters of the particular declaration.

5. The storage medium of claim 4, wherein the type of ambient condition is one of a plurality of ambient condition types, the plurality of asset capability abstractions comprise a respective capability abstraction corresponding to each one of the plurality of ambient condition types.

6. The storage medium of claim 5, wherein the plurality of ambient condition types comprise an illuminance, temperature, humidity, and access, and the plurality of job abstractions comprises an illuminance ambient abstraction corresponding to the illuminance ambient condition type, a temperature ambient abstraction corresponding to the temperature ambient condition type, a humidity ambient abstraction corresponding to the humidity ambient condition type, and an access ambient abstraction corresponding to the access ambient condition type.

7. The storage medium of claim 4, wherein the parameters comprise a value parameter to identify a level at which the corresponding ambient condition is to be maintained.

8. The storage medium of claim 7, wherein the parameters further comprise a location parameter identifying a location within a physical environment in which the corresponding ambient condition is to be maintained.

9. The storage medium of claim 7, wherein the parameters further comprise a time parameter identifying a time window in which the corresponding ambient condition is to be maintained.

10. The storage medium of claim 7, wherein the parameters further comprise a user parameter identifying one or more users for which the corresponding ambient condition is to be maintained.

11. The storage medium of claim 2, wherein the declaration comprises a tuple.

12. The storage medium of claim 1, wherein the two or more asset capability abstractions comprise at least one sensor-type asset capability abstraction and at least one actuator-type asset capability abstraction.

13. The storage medium of claim 1, wherein the user input is received through a declarative programming tool.

14. The storage medium of claim 13, wherein the data comprises at least a portion of an Internet of Things (IoT) application developed using the declarative programming tool.

15. The storage medium of claim 14, wherein the data is for use in launching instances of the IoT application in any one of a plurality of environments using any one of a plurality of different sets of devices.

16. The storage medium of claim 1, wherein the set of job abstractions comprises two or more job abstractions and the resulting IoT application is capable of directing the system to perform a plurality of jobs corresponding to the two or more job abstractions.

17. A method comprising:
receiving at least one user input comprising an identification of a set of job abstractions, wherein each job abstraction in the set of job abstractions comprises a respective one of a plurality of defined job abstractions and each of the plurality of defined job abstractions are mapped to two or more asset capability abstractions in a plurality of defined asset capability abstractions; and
processing the user input to generate data, based on the set of job abstractions, wherein the data are executable by a machine to:
determine a set of asset capability abstractions in the plurality of asset capability abstractions corresponding to the set of job abstractions;
determine that a set of devices in an environment possess capabilities corresponding to the set of asset capability abstractions; and
launch a system comprising the set of devices to implement jobs corresponding to the set of job abstractions.

18. (canceled)

19. A system comprising:
one or more processor devices;
one or more memory elements; and
a declarative programming tool, executable by the one or more processor devices, to:
receive, through a user interface, a set of declarations, wherein each declaration in the set of declarations identifies a respective one of a plurality of ambient abstractions, each ambient abstraction is mapped to two or more asset capability abstractions in a plurality of defined asset capability abstractions and corresponds to a job to maintain an ambient condition within an environment using a system, and each declaration in the set of declarations further identifies respective parameters for a corresponding job defined by the declaration;
determine a set of asset capability abstractions corresponding to the ambient abstractions identified in the set of declarations; and
generate program data, from the declarations, executable to implement a system comprising one or more devices with capabilities corresponding to capabilities represented by the set of asset capability abstractions, wherein the system is to perform the jobs defined in the set of declarations.

20. The system of claim 19, further comprising a system manager executable by one or more processor devices to:
receive the program data generated by the declaration programming tool;
discovery a plurality of assets within the environment, wherein the plurality of assets are hosted on one or more devices;
determine that each of the plurality of assets corresponds to one or more of the set of asset capabilities; and
cause implementation of the jobs defined in the set of declarations using the plurality of assets.

21. (canceled)

22. (canceled)

23. The system of claim 20, further comprising a gateway device to communicate with the one or more devices, wherein the system manager is implemented on the gateway device.

24. The system of claim 20, wherein the system manager comprises the declarative programming tool.

25. The system of claim 19, wherein the parameters comprise:
a value parameter to identify a level at which the corresponding ambient condition is to be maintained,
a location parameter identifying a location within the environment in which the corresponding ambient condition is to be maintained, and
a time parameter identifying a time window in which the corresponding ambient condition is to be maintained.
